(19) United States
(12) Patent Application Publication
(10) Pub. No.: US 2024/0104093 A1
(43) Pub. Date: Mar. 28, 2024

(54) ENRICHING UNSTRUCTURED COMPUTER CONTENT WITH DATA FROM STRUCTURED COMPUTER DATA SOURCES FOR ACCESSIBILITY

(71) Applicant: INTERNATIONAL BUSINESS MACHINES CORPORATION, ARMONK, NY (US)

(72) Inventors: Michael Drzewucki, Woodbridge, VA (US); Elinna Shek, Ashburn, VA (US); Keith Gregory Frost, Delaware, OH (US); Christopher F. Ackermann, Fairfax, VA (US); Charles E. Beller, Baltimore, MD (US)

(21) Appl. No.: 17/934,760

(22) Filed: Sep. 23, 2022

(51) Int. Cl. G06F 16/2453; G06F 16/248; G06F 40/169; G06F 40/40

(52) U.S. Cl. CPC G06F 16/24534; G06F 16/248; G06F 40/169; G06F 40/40

(57) ABSTRACT

A method for automatically annotating unstructured computer content associated with computer resources with additional contextual information from structured computer data sources is provided. The method may include, automatically identifying data elements within the unstructured computer content and matching extraction templates to the data elements. The method may further include automatically extracting an entity from the data elements using the extraction templates. The method may further include querying the structured computer data sources using the extracted entity to identify a data record in the structured computer data sources matching the entity. The method may further include extracting data from the data record and generating natural language text using the extracted data. The method may further include automatically annotating the unstructured computer content with the additional contextual information by inserting the generated natural language text into the unstructured computer content.

### BACKGROUND

The present invention relates generally to the field of computing, and more specifically, to annotating unstructured computer content with additional information from structured databases in a format consumable by accessibility and other tools.

Generally, data tagging may be used to organize information more efficiently by associating pieces of information (from websites or photos, for example) with tags, or keywords. For instance, tagging unstructured data is a commonly used method to support grouping documents into like clusters which may, in turn, support search engines and improve the performance and reliability of recommendation engines. More specifically, a tag may be a non-hierarchical keyword or term assigned to a piece of information (such as an internet bookmark, digital image, or computer file) and may serve as metadata for that piece of information. This kind of metadata helps describe an item and allows it to be found again by browsing or searching. Often, simple tags are added to a document, which is stored in a metadata field along with the full text. In other areas, text and elements in an unstructured document may be linked to records with the goal to add context to the unstructured document. An example is the linking between pages on Wikipedia, which may take a reader to other pages about entities mentioned in the text.

### SUMMARY

A method for automatically annotating unstructured computer content with additional contextual information from structured computer data sources is provided. The method may include, in response to receiving the unstructured computer content, automatically identifying data elements within the unstructured computer content and matching one or more extraction templates to the data elements. The method may further include, based on identifying the one or more extraction templates matching the data elements, automatically extracting at least one entity from the data elements using the one or more extraction templates. The method may further include querying the structured computer data sources using the extracted at least one entity to identify at least one data record in the structured computer data sources matching the extracted at least one entity. The method may further include, in response to identifying a match between the extracted at least one entity and the at least one data record, extracting data from the at least one data record and generating natural language text using the extracted data, wherein the generated natural language text includes the additional contextual information associated with the extracted at least one entity based on the at least one data record. The method may further include automatically annotating the unstructured computer content with the additional contextual information by inserting the generated natural language text into the unstructured computer content.

A computer system for automatically annotating unstructured computer content with additional contextual information from structured computer data sources is provided. The computer system may include one or more processors, one or more computer-readable memories, one or more computer-readable tangible storage devices, and program instructions stored on at least one of the one or more storage devices for execution by at least one of the one or more processors via at least one of the one or more memories, whereby the computer system is capable of performing a method. The method may include, in response to receiving the unstructured computer content, automatically identifying data elements within the unstructured computer content and matching one or more extraction templates to the data elements. The method may further include, based on identifying the one or more extraction templates matching the data elements, automatically extracting at least one entity from the data elements using the one or more extraction templates. The method may further include querying the structured computer data sources using the extracted at least one entity to identify at least one data record in the structured computer data sources matching the extracted at least one entity. The method may further include, in response to identifying a match between the extracted at least one entity and the at least one data record, extracting data from the at least one data record and generating natural language text using the extracted data, wherein the generated natural language text includes the additional contextual information associated with the extracted at least one entity based on the at least one data record. The method may further include automatically annotating the unstructured computer content with the additional contextual information by inserting the generated natural language text into the unstructured computer content.

A computer program product for automatically annotating unstructured computer content with additional contextual information from structured computer data sources is provided. The computer program product may include one or more computer-readable storage devices and program instructions stored on at least one of the one or more tangible storage devices, the program instructions executable by a processor. The computer program product may include program instructions to, in response to receiving the unstructured computer content, automatically identify data elements within the unstructured computer content and matching one or more extraction templates to the data elements. The computer program product may further include program instructions to, based on identifying the one or more extraction templates matching the data elements, automatically extract at least one entity from the data elements using the one or more extraction templates. The computer program product may also include program instructions to query the structured computer data sources using the extracted at least one entity to identify at least one data record in the structured computer data sources matching the extracted at least one entity. The computer program product may include program instructions to, in response to identifying a match between the extracted at least one entity and the at least one data record, extract data from the at least one data record and generating natural language text using the extracted data, wherein the generated natural language text includes the additional contextual information associated with the extracted at least one entity based on the at least one data record. The computer program product may further include program instructions to automatically annotate the unstructured computer content with the additional contextual information by inserting the generated natural language text into the unstructured computer content.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary computing environment according to one embodiment;

FIG. 2 is an operational flowchart illustrating the steps carried out by a program for automatically annotating unstructured computer content with additional contextual information from structured computer data sources according to one embodiment;

FIG. 3 is an example diagram further illustrating the operational flowchart depicted in FIG. 2 according to one embodiment;

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Embodiments of the present invention relate generally to the field of computing, and more particularly, to automatically annotating unstructured computer content with additional contextual information from structured computer data sources. Specifically, the unstructured computer content is automatically annotated as the unstructured computer content is received by a computer system to, for instance, allow accessibility tools such as screen readers to read the additional contextual information as well as reduce the impact on query time performance for question answering systems. The present invention identifies elements to be annotated in the unstructured computer content, and thereafter, identifies a structured data record that may be associated the data elements from the unstructured computer content. Furthermore, the present invention may transform the data from the structured computer data record into a sentence/phrase that provides additional contextual information that is inserted into the unstructured computer content/document. Therefore, unlike related approaches that may simply tag or include metadata with unstructured computer content, the present invention inserts contextual information directly into the unstructured computer content as part of document text, for example, as a sentence/phrase in the unstructured computer content or as footnotes. In turn, screen readers and other accessibility tools may capture the additional contextual information without any modification. Furthermore, the present invention supports other tools that discover information from unstructured computer content, such as answer retrieval in question and answering systems.

More specifically, and as previously described, data tagging may be used to organize information more efficiently by associating pieces of information (from websites or photos, for example) with tags or keywords. For instance, tagging unstructured data is a commonly used method for grouping documents into like clusters which may, in turn, support search engines and improve the performance and reliability of recommendation engines. More specifically, a tag may be a non-hierarchical keyword or term assigned to a piece of information (such as document text, an internet bookmark, digital image, or computer file) and may serve as metadata for identifying that piece of information. For example, this kind of metadata helps describe an element and allows that element to be found again by a browsing or searching engine. However, simply annotating unstructured computer content and documents with metadata fall short in supporting accessibility tools, such as screen readers, as well as question answering tools. Such tools are used to read document text, which may include footnotes of a document, but are typically unable to read metadata.

Therefore, it may be advantageous, among other things, to provide a method, computer system, and computer program product for automatically annotating unstructured computer content with additional contextual information from structured computer data sources directly inserted into. Specifically, the method, computer system, and computer program product may, in response to receiving the unstructured computer content, automatically identify data elements within the unstructured computer content and matching one or more extraction templates to the data elements. Then, the method, computer system, and computer program product may, based on identifying the one or more extraction templates matching the data elements, automatically extract at least one entity from the data elements using the one or more extraction templates. Next, the method, computer system, and computer program product may query the structured computer data sources using the extracted at least one entity to identify at least one data record in the structured computer data sources matching the extracted at least one entity. Thereafter, the method, computer system, and computer program product may, in response to identifying a match between the extracted at least one entity and the at least one data record, extract data from the at least one data record and generating natural language text using the extracted data, wherein the generated natural language text includes the additional contextual information associated with the extracted at least one entity based on the at least one data record. Next, the method, computer system, and computer program product may automatically annotate the unstructured computer content with the additional contextual information by inserting the generated natural language text into the unstructured computer content.

The present invention may be a system, a method, and/or a computer program product at any possible technical detail level of integration. The computer program product may include a computer readable storage medium (or media) having computer readable program instructions thereon for causing a processor to carry out aspects of the present invention.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method, and program product to determine whether directional input is received along with a query and, accordingly, adjust presented display content to include a referenced object in a center of a screen of a primary device.

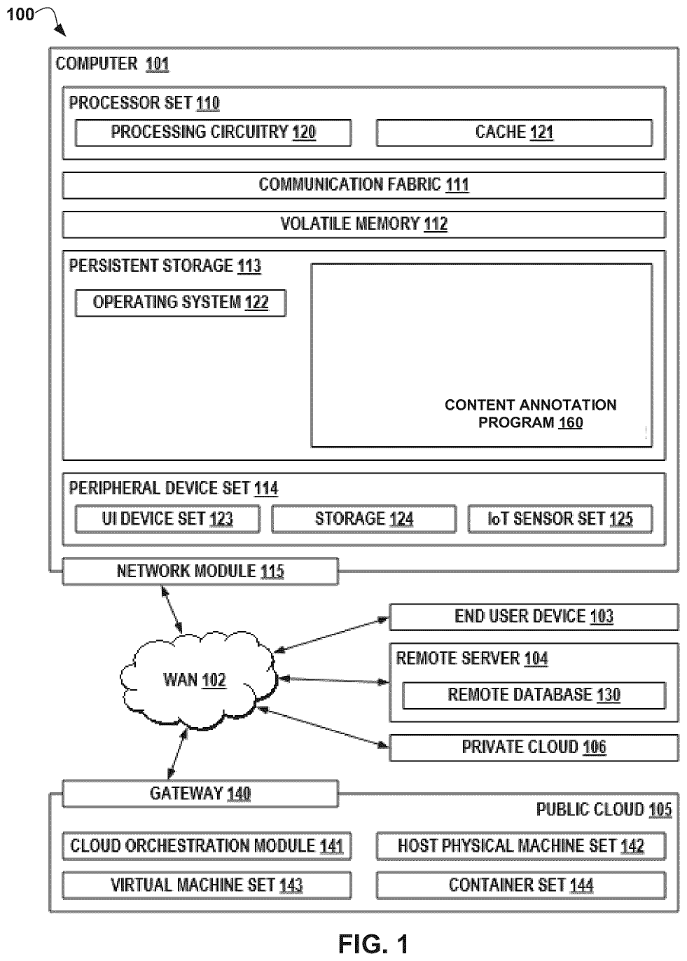

Referring to FIG. 1, an exemplary computing environment 100 is depicted, according to at least one embodiment. Computing environment 100 contains an example of an environment for the execution of at least some of the computer code involved in performing the inventive methods, such as a content annotation program 160. In addition to block 160, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory 112 may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage 113 allows writing of data, deletion of data and re-writing of data. Some familiar forms of persistent storage 113 include magnetic disks and solid state storage devices. Operating system 122 may take several forms, such as various known proprietary operating systems or open source Portable Operating System Interface type operating systems that employ a kernel. The code included in block 160 typically includes at least some of the computer code involved in performing the inventive methods.

Peripheral device set 114 includes the set of peripheral devices of computer 101. Data communication connections between the peripheral devices 114 and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector and/or accelerometer.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN 102 and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments the private cloud 106 may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

According to the present embodiment, the content annotation program 160 may be a program capable of automatically annotating unstructured computer content with additional contextual information from structured computer data sources by: in response to receiving the unstructured computer content, automatically identifying data elements within the unstructured computer content and matching one or more extraction templates to the data elements; based on identifying the one or more extraction templates matching the data elements, automatically extracting at least one entity from the data elements using the one or more extraction templates; querying the structured computer data sources using the extracted at least one entity to identify at least one data record in the structured computer data sources matching the extracted at least one entity; in response to identifying a match between the extracted at least one entity and the at least one data record, extracting data from the at least one data record and generating natural language text using the extracted data, wherein the generated natural language text includes the additional contextual information associated with the extracted at least one entity based on the at least one data record; and automatically annotating the unstructured computer content with the additional contextual information by inserting the generated natural language text into the unstructured computer content.

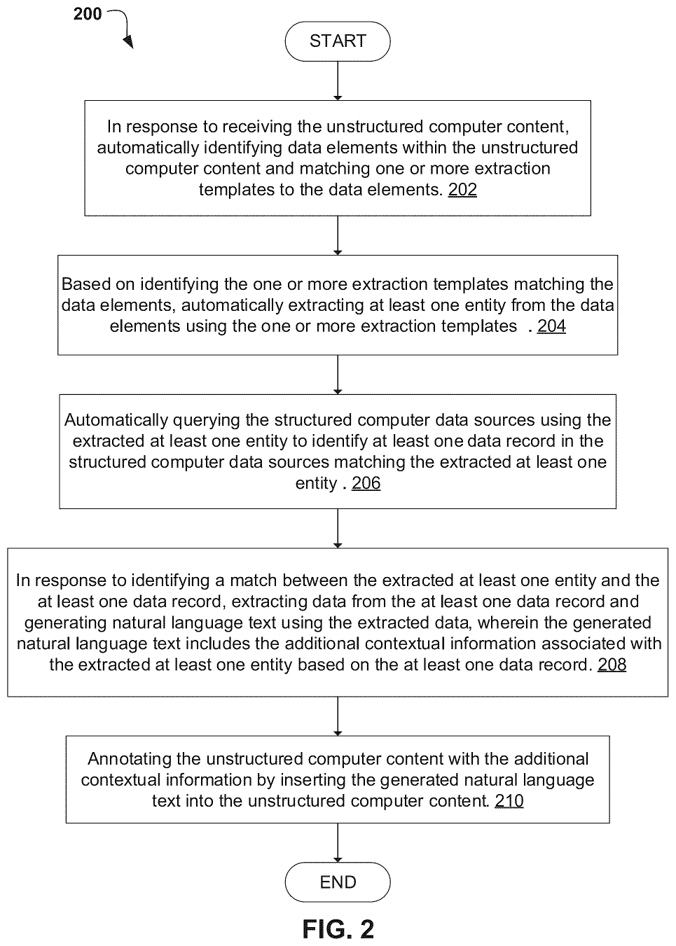

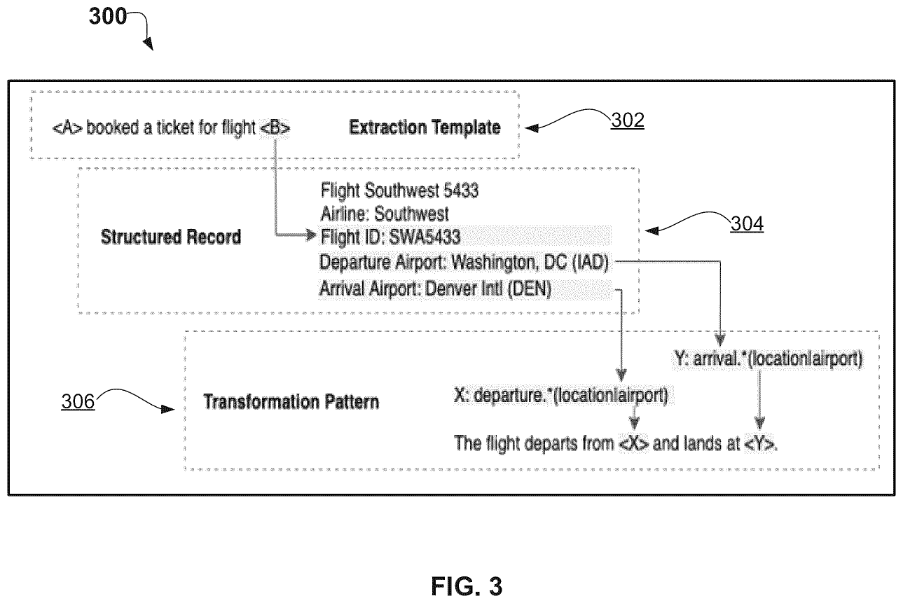

Furthermore, notwithstanding depiction in computer 101, the content annotation program 160 may be stored in and/or executed by, individually or in any combination, end user device 103, remote server 104, public cloud 105, and private cloud 106. The content annotation program is explained in further detail below with respect to FIGS. 2 and 3.

Referring now to FIG. 2, an operational flowchart 200 further illustrating the steps carried out by the content annotation program 160 for automatically annotating unstructured computer content with additional contextual information from structured computer data sources is depicted. Specifically, at 202, the content annotation program 160 may, in response to receiving the unstructured computer content, automatically identifying data elements within the unstructured computer content and matching one or more extraction templates to the data elements. More specifically, for example, the unstructured computer content may include information associated with computer resources (such as websites, online documents, articles, blogs, etc.) that either does not have a pre-defined data model or is not organized in a pre-defined manner (as opposed to structured content, which may be included and organized in a database). Unstructured computer content may typically be text-heavy, but may contain other data such as dates, numbers, as well as media (i.e. audio, video, media and entertainment data, surveillance data, geo-spatial data, weather data). According to one embodiment, the unstructured computer content may be received, for example, from an uploaded document, a website, a program or app, and/or from information entered on a user interface such as a chat/text interface. Furthermore, according to one embodiment, the data elements identified by the content annotation program 160 may include the different types of data from the unstructured computer content described above, including text, dates, numbers, other alphanumeric and non-alphanumeric characters, as well as media. Furthermore, according to one embodiment, the data elements identified and then extracted by the content annotation program 160 may be data elements that are candidates for enrichment because the data elements may have additional contextual information from structured computer data sources that may be inserted into the unstructured computer content.

Also, as described above, the content annotation program 160 may automatically identify the data elements within the unstructured computer content by matching one or more extraction templates to the data elements. Specifically, according to one embodiment, the content annotation program 160 may include both an extraction template lexicon as well as a corresponding transformation pattern lexicon associated with the extraction templates. Furthermore, according to one embodiment, the content annotation program 160 may include a database (for example, database storage 124 and/or Remote server 104 that includes remote database 130 described in FIG. 1) that may store the extraction template lexicon which may further include the one or more extraction templates, as well as store the transformation pattern lexicon which may further include one or more transformation templates associated with the extraction templates According to one embodiment, an extraction template is a feature that may simplify the data extraction process by using pre-defined sets of expressions/metrics/dimensions for identifying entities and patterns of entities in unstructured content/text. For example, an extraction template may include a regular text expression that pre-defines and specifies an entity and the pattern of the entities in the expression which may be matched to text in the unstructured computer content. Accordingly, an extraction template may contain placeholders for entities that are matched to the unstructured content/text. An example for such an extraction template, as well as a corresponding regular expression representing the extraction template, may include the following:
Extraction Template: <A> booked a ticket for flight <B>.
Regular Expression: ([\w])+ booked a ticket for flight ([\w]+)

In the above extraction template example, <A> and <B> are placeholders for entities whose context may be pre-defined according to an extraction template lexicon and may be matched to text in the unstructured computer content to thereby identify the entities in the unstructured computer content. For example, the above extraction template/expression may be matched to the following sentence in the received unstructured computer content:
Sam Smith booked a ticket for flight SWA5433.

As such, and as depicted at 204 in FIG. 2, the content annotation program 160 may, based on identifying the one or more extraction templates matching the data elements, automatically extracting at least one entity from the data elements using the one or more extraction templates. Therefore, based on the above example, the content annotation program 160 may identify “Sam Smith” and “SWA5433” as entities which may be extracted from the received unstructured computer content. Another example may include the extraction template/expression:
<A> works for <B> at the <C>, <D> location.

In this case, the content annotation program 160 may match the extraction template to data elements (i.e. text) within the unstructured computer content, such as matching the extraction template/expression to the sentence:
Sam Smith works for IBM at the Raleigh, NC location.

Accordingly, based on the extraction template, “Sam Smith”, “IBM”, “Raleigh”, and “NC” may be identified as entities which may be extracted by the content annotation program 160 from the received unstructured computer content. As previously described, the content annotation program 160 may include an extraction template lexicon which may further include multiple extraction templates to be matched to data elements in the unstructured computer content which, in turn, may be used for extracting entities and/or other information (including other terms). Furthermore, the extraction templates may be flexible enough to accommodate missing information. Therefore, if an extraction template requires several entity substitutions but only some of those substitutions can be satisfied, the content annotation program 160 may accept partial substitutions and/or may employ confidence scores or a ranking system for matching the extraction templates to the unstructured computer content. Therefore, any lack of information may be taken into account by the content annotation program 160 when calculating the confidence of a match and for subsequent processing. In turn, extraction templates may be created and included in the content annotation program 160 before receiving and being applied to the unstructured computer content. For example, in one embodiment, users may create extraction templates by marking sentences, phrases, and entities in different sets of unstructured computer content to serve as a basis for identifying information in unstructured computer content received at a future time. Then, for example, pattern mining and machine learning can be used to identify a set of patterns that cover the marked information.

Thereafter, and as depicted at 206 in FIG. 2, the content annotation program 160 may automatically query the structured computer data sources using the extracted at least one entity to identify at least one data record in the structured computer data sources matching the extracted at least one entity. As previously described, the extracted entities may be candidates for enrichment because such entities may have additional contextual information from structured computer data sources that may be inserted into the unstructured computer content. Therefore, to identify such additional contextual information, the content annotation program 160 may use the identified and extracted entities from step 204 in a query for querying structured computer data sources.

FIG. 3 includes a diagram 300 further illustrating the operational flowchart depicted in FIG. 2. Specifically, in FIG. 3, diagram 300 further describes using the extracted at least one entity to query structured computer data sources for identifying at least one data record associated with the at least one entity in the structured computer data sources. As depicted in FIG. 3, and as previously described at step 204, the content annotation program 160 may use an extraction template 302 to identify an entity in the unstructured computer content. More specifically, and based on a previously described example, extraction template 302 may include the expression: <A> booked a ticket for flight <B>. Also, as previously described, the content annotation program 160 may match the extraction template to data elements (i.e. text) within the unstructured computer content, such as matching the expression to the sentence: “Sam Smith booked a ticket for flight SWA5433.” As such, based on the extraction template matching the sentence, the content annotation program 160 may identify “Sam Smith” and “SWA5433” as entities in the unstructured computer content, and in turn, may use the entities to query a structured database to identify additional contextual information associated with the entities. For example, the content annotation program 160 may include the entity “SWA5433” in a query by, for example, entering “SWA5433” into a search engine associated with the content annotation program 160 to identify information that may match the entity in structured computer data sources, such as internal and external databases, internet resources, websites, and other computer resources and databases capable of receiving a query for information stored therewith.

As depicted at 302 in FIG. 3, for example, <B> may represent the extracted entity, “SWA5433,” based on the extraction template matching the text described above. In turn, at 304, the content annotation program 160 may use the extracted entity, “SWA5433”, in a query such as a search query through a search engine associated with an internet resource and/or associated with internal or external databases. For example, the content annotation program 160 may be associated with an airline website, whereby text may be received in the form of website text that includes the example sentence described above comprising “SWA5433”. Furthermore, the airline website may have a structured database, such as an associated internal database that keeps track of flight information. Therefore, in response to receiving the example sentence described above and matching an extraction template to the sentence to identify the entity “SWA5433”, the content annotation program 160 may use “SWA5433” in a query to the associated internal database that keeps track of flight information to automatically identify additional contextual information associated with “SWA5433.” According to one embodiment, the content annotation program 160 may also generally query internet resources for additional contextual information by using the entity “SWA5433” in an internet search engine to identify top results for the entity “SWA5433,” as may be known in the art.

Furthermore, according to one embodiment, in addition to the identification of a certain entity as well as other information in the unstructured computer content, the extraction templates may be used to identify a certain context associated with the entity and/or other information. For example, and as previously described, extraction templates may be created and included in the content annotation program 160 before receiving and being applied to the unstructured computer content. Also, as previously described, users may create extraction templates by marking sentences, phrases, and entities in different sets of unstructured computer content to serve as a basis for identifying information in unstructured computer content received at a future time. Such markings may be used for pattern mining as well as for identifying a context associated with a term. Thus, for example, in creating the extraction template—“<A> booked a ticket for flight <B>”—the extraction template may be marked/designated as providing an indication of a flight context, and therefore, a matching sentence in the unstructured computer content may be associated with a flight context. Furthermore, the designated context may further indicate that a type of data record associated with a flight context may match the entities for providing the additional contextual information.

As previously described with respect to step 206 in FIG. 2, the content annotation program 160 may use the extracted at least one entity to query structured computer data sources for identifying at least one data record in the structured computer data sources that may match the extracted at least one entity. Therefore, as further depicted at 304 in FIG. 3, based on the query to, for example, the associated internal database or the internet resources, the content annotation program 160 may identify top results, or more specifically, a data record matching the extracted at least one entity that is “SWA5433.” According to one embodiment, the structured computer data source may respond with a list of records that may match the query to some degree. As such, the content annotation program 160 may use a confidence score to calculate a degree to which a data record matches the extracted information based on the extraction template. The confidence calculations may differ based on a use case. According to one embodiment, the content annotation program 160 may calculate the confidence score based on whether a fraction of elements from the query are exactly matched to data in the structured record. For example, if only ⅓ of the alphanumeric characters from a data record matches the alphanumeric characters of an entity in a query, then the content annotation program 160 may present that data record with a confidence score of 30% to represent the degree to which the data record matches the query. Additionally, the content annotation program 160 may use approximate matching to yield higher recall on structured data record matches. In turn, the data record with the highest confidence score may be considered the best match to the query and, therefore, the extracted information based on the extraction template pattern. According to one embodiment, the structured computer data source may not have any records that match the query to a sufficient degree. Hence, the content annotation program may additionally use a threshold score to match only records whose confidence score meets or exceeds a specific threshold—for example, records with a confidence score above 90% may only be considered for a match. Thus, if a match is found and the confidence score meets or exceeds the threshold, the content annotation program 160 may provide that record for further processing.

In turn, and as depicted at 304, the content annotation program 160 may identify a data record that may match the information in the query, and therefore, may include potential additional contextual information associated with the entity. Continuing the previous example, based on the query received, for example, by the associated internal database or the internet search engine, the content annotation program 160 may receive results matching the query “SWA5433.” More specifically, and as depicted at 304, the content annotation program 160 may identify “SWA5433” in a data record listing “SWA5433” as a Flight ID as well as includes additional information with respect to the Flight ID SWA5433. For instance, and as depicted at 304, the data record may include additional contextual information such as: Flight Southwest 5433; Airline: Southwest; Departure Airport: Washington, D.C. (IAD); Arrival Airport: Denver Intl (DEN).

Thereafter, at 208, in response to identifying a match between the extracted at least one entity and the at least one data record, extracting data from the at least one data record and generating natural language text using the extracted data, wherein the generated natural language text includes the additional contextual information associated with the extracted at least one entity based on the at least one data record. More specifically, and as previously described with respect to step 202, the content annotation program 160 may include both an extraction template lexicon (previously described) as well as a corresponding transformation pattern lexicon associated with the extraction template lexicon. Like the extraction templates associated with the extraction template lexicon which may be used to extract information from unstructured computer content, the content annotation program 160 may also include one or more transformation templates that correspond to an extraction template. As will be further described, the transformation templates may be used to extract structured data received from the structured computer data sources to guide the annotation of the unstructured computer content with the structured data. More specifically, the content annotation program 160 may use transformation templates to construct a sentence and/or phrase to be inserted into the unstructured computer content, whereby a given transformation template may include placeholders to be filled by the structured data. For example, for the extraction template—“<A> booked a ticket for flight <B>”—a corresponding transformation template that may be associated with that extraction template may include the transformation template:
Transformation template: The flight departs from <X> and lands at <Y>.

In the example, <X> and <Y> are placeholders for structured data. Each placeholder may be matched to a field and/or data associated with a field in a structured data record. Hence, every placeholder may include an associated regular expression which can be matched against a field (such as a field name) and data of a structured data record. In turn, the content annotation program 160 may, for example, insert the data from matching field and values of the structured data record into the transformation template. For example, and as depicted at 306, the regular expressions for placeholders <X> and <Y> may be as follows.
X: departure.*(locationlairport) and Y: arrival.*(locationlairport)

Therefore, the content annotation program 160 may match X:departure.*(locationlairport) and Y:arrival.*(locationlairport) against data such as field names and values (including text) from the structured data record. According to one embodiment, and similar to the previously described confidence scores used to determine the degree to which a data record may match the extracted information based on the extraction template, the content annotation program 160 may use a confidence score to determine a degree to which information from the data record matches the placeholders in the transformation template. According to one embodiment, the content annotation program 160 may calculate the confidence score based on whether a fraction of elements from the data (including information such as field names) in the structured data record are matched to the placeholder expressions in the transformation template. As an example, if only ⅓ of alphanumeric characters from a field name matches the expressions corresponding to the placeholders associated with the transformation templates, then the content annotation program 160 may determine a confidence score of 30%. Likewise, the content annotation program 160 may additionally use a threshold score to match only data whose confidence score meets or exceeds a specific threshold. In turn, the data with the highest confidence score may be considered the best match to the placeholder expression in the transformation template, and therefore, the data (including any values/text) may be extracted to fill the placeholders in the transformation templates.

Referring back to FIG. 3, for example, the content annotation program 160 may match the placeholder expressions—X:departure.*(locationlairport) and Y:arrival.*(locationlairport)—associated with the placeholders in the example transformation template, “The flight departs from <X> and lands at <Y>”, against data in the structured data record. Thereafter, the content annotation program 160 may resultingly determine that the fields—Departure Airport: Washington, D.C. (IAD); Arrival Airport: Denver Intl (DEN)— may match the placeholder expressions. As such, the content annotation program 160 may extract the data from such fields to fill the placeholders in the transformation template, and as previously described, may use the transformation template and the extracted data to construct a sentence and/or phrase to be inserted into the unstructured computer content, such as:
The flight departs from Washington, DC (IAD) and lands at Denver Intl (DEN).

Thereafter, and as depicted at 210 in FIG. 2, the content annotation program 160 may automatically annotate the unstructured computer content with the additional contextual information by inserting the generated natural language text into the unstructured computer content. Specifically, once the content annotation program 160 has applied the transformation template to generate sentence(s)/phrase(s), the sentence(s)/phrase(s) may then be inserted into the document. According to one embodiment, insertion location may depend on specific use cases and how the additional contextual information may be consumed. For example, the content annotation program 160 may replace or append the natural language text to the extraction template matches. More specifically, for example, given document or website text that includes the extraction template matching sentence—“Sam Smith booked a ticket for flight SWA5433”— the content annotation program 160 may follow such a sentence by appending/adding the following sentence—“The flight departs from Washington, DC (IAD) and lands at Denver Intl (DEN)”—in line with the document/website text such that a screen reader may capture the text without additional processing, i.e. the sentence(s)/phrase(s) are inserted into the document text itself as followed.
Sam Smith booked a ticket for flight SWA5433. The flight departs from Washington, DC (IAD) and lands at Denver Intl (DEN).

The content annotation program 160 may also be used in conjunction with a question answering (QA) system, whereby as previously described, the unstructured computer content, such as document and website text, may be automatically annotated upon creation and/or receipt by the content annotation program 160 inserting the generated natural language text in the unstructured computer content such that a QA system could process the annotated document without any undue look ups to structured computer data sources (thereby improving QA system runtime performance). Furthermore, according to one embodiment, the content annotation program 160 may insert the sentence(s)/phrase(s) as footnotes. In such a scenario, the content annotation program 160 may insert a reference to the footnote in line with the document text (such as see footnote n) and a footnote would be appended to the document text (such as at a bottom of a document page). According to one embodiment, the content annotation program 160 may additionally provide a user interface for adjusting the insertion location of the additional contextual information (i.e. the constructed natural language text). However, in either case, the content annotation program 160 may facilitate screen reading tools to capture additional contextual information associated with document/website text, whereby such tools generally do not have the ability to access outside structured computer data sources but do have built in support for capturing document text and footnotes.

It may be appreciated that FIGS. 2-3 provide only illustrations of one implementation and does not imply any limitations with regard to how different embodiments may be implemented. Many modifications to the depicted environments may be made based on design and implementation requirements.

As previously described, the present invention may be a system, a method, and/or a computer program product. The computer program product may include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

1. A computer-implemented method for automatically annotating unstructured computer content with additional contextual information from different structured computer data sources, comprising:
in response to receiving the unstructured computer content, automatically identifying data elements within the unstructured computer content and matching one or more extraction templates to the data elements;
based on identifying the one or more extraction templates matching the data elements, automatically extracting at least one entity from the data elements using the one or more extraction templates;
automatically querying the different structured computer data sources using the extracted at least one entity to identify at least one data record in the different structured computer data sources matching the extracted at least one entity;
in response to identifying a match between the extracted at least one entity and the at least one data record, extracting data from the at least one data record and generating natural language text using the extracted data, wherein the generated natural language text includes the additional contextual information associated with the extracted at least one entity based on the at least one data record; and
annotating the unstructured computer content with the additional contextual information by inserting the generated natural language text into the unstructured computer content.

2. The computer-implemented method of claim 1, further comprising:
a database comprising an extraction template lexicon and a transformation pattern lexicon, wherein the extraction template lexicon further comprises the one or more extraction templates, and wherein the transformation pattern lexicon further comprises one or more transformation templates associated with the one or more extraction templates.

3. The computer-implemented method of claim 1, wherein matching the one or more extraction templates to the data elements further comprises:
determining a confidence score for each potential match between an extraction template and the data elements; and
identifying the extraction template with a highest confidence score as the match to the data elements.

4. The computer-implemented method of claim 1, wherein extracting data from the at least one data record further comprises:
matching transformation templates to the data associated with the at least one data record;
determining a confidence score for each potential match between a transformation template and the data within the at least one data record; and
identifying the transformation template with a highest confidence score as the match to the data associated with the at least one data record.

5. The computer-implemented method of claim 4, wherein generating the natural language text using the extracted data further comprises:
in response to identifying the transformation template with the highest confidence score as the match to the data associated with the at least one data record, extracting the data, and filling placeholders within the transformation template with the extracted data from the at least one data record to generate the natural language text.

6. The computer-implemented method of claim 5, wherein the generated natural language text is generated based on the transformation template and comprises at least one of a sentence and a phrase.

7. The computer-implemented method of claim 1, wherein annotating the unstructured computer content with the additional contextual information by inserting the generated natural language text into the unstructured computer content further comprises at least one of:
appending the generated natural language text to the data elements matching the one or more extraction templates, replacing the data elements matching the one or more extraction templates with the generated natural language text, and inserting the generated natural language text as a footnote into the unstructured content.

8. A computer system for automatically annotating unstructured computer content with additional contextual information from different structured computer data sources, comprising:
one or more processors, one or more computer-readable memories, one or more computer-readable tangible storage devices, and program instructions stored on at least one of the one or more storage devices for execution by at least one of the one or more processors via at least one of the one or more memories, wherein the computer system is capable of performing a method comprising:
in response to receiving the unstructured computer content, automatically identifying data elements within the unstructured computer content and matching one or more extraction templates to the data elements;
based on identifying the one or more extraction templates matching the data elements, automatically extracting at least one entity from the data elements using the one or more extraction templates;
automatically querying the different structured computer data sources using the extracted at least one entity to identify at least one data record in the different structured computer data sources matching the extracted at least one entity;
in response to identifying a match between the extracted at least one entity and the at least one data record, extracting data from the at least one data record and generating natural language text using the extracted data, wherein the generated natural language text includes the additional contextual information associated with the extracted at least one entity based on the at least one data record; and
annotating the unstructured computer content with the additional contextual information by inserting the generated natural language text into the unstructured computer content.

9. The computer system of claim 8, further comprising:
a database comprising an extraction template lexicon and a transformation pattern lexicon, wherein the extraction template lexicon further comprises the one or more extraction templates, and wherein the transformation pattern lexicon further comprises one or more transformation templates associated with the one or more extraction templates.

10. The computer system of claim 8, wherein matching the one or more extraction templates to the data elements further comprises:
determining a confidence score for each potential match between an extraction template and the data elements; and
identifying the extraction template with a highest confidence score as the match to the data elements.

11. The computer system of claim 8, wherein extracting data from the at least one data record further comprises:
matching transformation templates to the data associated with the at least one data record;
determining a confidence score for each potential match between a transformation template and the data within the at least one data record; and
identifying the transformation template with a highest confidence score as the match to the data associated with the at least one data record.

12. The computer system of claim 11, wherein generating the natural language text using the extracted data further comprises:
in response to identifying the transformation template with the highest confidence score as the match to the data associated with the at least one data record, extracting the data, and filling placeholders within the transformation template with the extracted data from the at least one data record to generate the natural language text.

13. The computer system of claim 12, wherein the generated natural language text is generated based on the transformation template and comprises at least one of a sentence and a phrase.

14. The computer system of claim 8, wherein annotating the unstructured computer content with the additional contextual information by inserting the generated natural language text into the unstructured computer content further comprises at least one of:
appending the generated natural language text to the data elements matching the one or more extraction templates, replacing the data elements matching the one or more extraction templates with the generated natural language text, and inserting the generated natural language text as a footnote into the unstructured content.

15. A computer program product for automatically annotating unstructured computer content with additional contextual information from different structured computer data sources, comprising:
one or more computer-readable storage media and program instructions stored on at least one of the one or more computer-readable storage media, the program instructions executable by a processor, the program instructions comprising:
in response to receiving the unstructured computer content, automatically identifying data elements within the unstructured computer content and matching one or more extraction templates to the data elements;
based on identifying the one or more extraction templates matching the data elements, automatically extracting at least one entity from the data elements using the one or more extraction templates;
automatically querying the different structured computer data sources using the extracted at least one entity to identify at least one data record in the different structured computer data sources matching the extracted at least one entity;
in response to identifying a match between the extracted at least one entity and the at least one data record, extracting data from the at least one data record and generating natural language text using the extracted data, wherein the generated natural language text includes the additional contextual information associated with the extracted at least one entity based on the at least one data record; and
annotating the unstructured computer content with the additional contextual information by inserting the generated natural language text into the unstructured computer content.

16. The computer program product of claim 15, further comprising:
a database comprising an extraction template lexicon and a transformation pattern lexicon, wherein the extraction template lexicon further comprises the one or more extraction templates, and wherein the transformation pattern lexicon further comprises one or more transformation templates associated with the one or more extraction templates.

17. The computer program product of claim 15, wherein matching the one or more extraction templates to the data elements further comprises:
determining a confidence score for each potential match between an extraction template and the data elements; and
identifying the extraction template with a highest confidence score as the match to the data elements.

18. The computer program product of claim 15, wherein extracting data from the at least one data record further comprises:
matching transformation templates to the data associated with the at least one data record;
determining a confidence score for each potential match between a transformation template and the data within the at least one data record; and
identifying the transformation template with a highest confidence score as the match to the data associated with the at least one data record.

19. The computer program product of claim 18, wherein generating the natural language text using the extracted data further comprises:
in response to identifying the transformation template with the highest confidence score as the match to the data associated with the at least one data record, extracting the data, and filling placeholders within the transformation template with the extracted data from the at least one data record to generate the natural language text.

20. The computer program product of claim 15, wherein annotating the unstructured computer content with the additional contextual information by inserting the generated natural language text into the unstructured computer content further comprises at least one of:
appending the generated natural language text to the data elements matching the one or more extraction templates, replacing the data elements matching the one or more extraction templates with the generated natural language text, and inserting the generated natural language text as a footnote into the unstructured content.
